(19) United States
(12) Patent Application Publication
(10) Pub. No.: US 2012/0024842 A1
(43) Pub. Date: Feb. 2, 2012

(54) CIRCUIT ARRANGEMENT FOR AN INDUCTION COOKER, METHOD FOR OPERATING THE CIRCUIT ARRANGEMENT AND INDUCTION COOKER

(75) Inventors: Albert Thomann, Herisau (CH); Christian Fuchs, Bulach (CH); Martin Behle, Radevormwald (DE)

(73) Assignee: INDUCS AG, Herisau (CH)

(21) Appl. No.: 13/096,567

(22) Filed: Apr. 28, 2011

(30) Foreign Application Priority Data
Apr. 30, 2010 (CH) 652/10

(51) Int. Cl. H05B 6/04; H05B 6/02

(52) U.S. Cl. 219/660

(57) ABSTRACT

A circuit arrangement for an induction cooking device and an induction cooking device with a circuit of this kind, wherein the circuit includes a resonant circuit with at least one induction coil for the inductive heating of an induction cooking dish and at least one capacitor, as well as a variable circuit element for the variation of the inductivity and/or the capacity of the resonant circuit. The variable circuit element in preference is a choke controllable with direct current and the switching circuit in preference is operated with a constant frequency.

### BACKGROUND OF THE INVENTION

1. Field of the Invention

The invention is in the field of induction devices for gastronomy and concerns in particular an improved control system for induction cookers, which takes into account differing inductivities of cooking dish materials and is especially also suitable for multiple cooking field devices.

2. Description of Related Art

In case of cooking devices with multiple cooking fields there is the problem, that the magnetic fields of the individual induction coils of the cooking fields operated with differing frequencies mutually influence, resp., interfere with one another. This influence, in particular an undesirable noise production, is capable of being prevented, in that all cooking fields are operated with the same frequency. This, however, has the disadvantage, that only one frequency is available. Depending on the inductivity of a utilised pan material, the inductivity resonant circuit does not operate anymore with a desired or with an optimum frequency (resonance frequency). In addition it is not possible to readily operate with an independent power level. The variation of the resonance frequency is able to have the effect, that depending on the switching frequency, individual switches of the power stage are switched-on under voltage, and/or that briefly a short-circuit across the power stage is produced, until a corresponding recovery diode blocks. This leads to circuit losses.

A solution to this problem is, that an external protection wiring of the switches of the power stage is implemented (snubber circuit). While with such an external wiring unsuitable operating points cannot be prevented, however, higher switching-on currents are capable of being coped with. This, however, continues to lead to switching losses. In addition, a wiring of this kind is rather elaborate and correspondingly expensive.

It is therefore the object of the invention to provide a circuit arrangement for an induction device, a method for driving this circuit arrangement, as well as an induction device with a circuit arrangement of this kind, which eliminates the disadvantages of the known circuits for induction devices. In particular it is the object of the invention to provide a circuit arrangement and a method for driving a circuit arrangement of this kind, which enables a safe operating mode and an operation of an induction device comprising less switching losses and which in preference simultaneously eliminates the problem of magnetic fields influencing one another and oscillations of induction cooking fields located next to one another.

### BRIEF SUMMARY OF THE INVENTION

This object is achieved by the circuit arrangement, the method for driving the circuit arrangement and the induction cooking device, as they are described in the independent claims.

The circuit arrangement in accordance with the invention for an induction cooking device comprises a resonant circuit with at least one induction coil for the inductive heating of induction cooking ware and at least one capacitor. In addition, the resonant circuit comprises a variable circuit element for the variation of the inductivity and/or capacity of the resonant circuit. The variable circuit element, in preference, is formed by at least one controllable choke, sometimes also called throttle, wherein this at least one controllable choke, for example, is controlled by direct current (magnetic amplifier choke, half-cycle transductor). The choke is typically implemented as a reactor or inductor coil.

In order to operate the circuit in a safe zone, a switching frequency, which corresponds to a driving frequency of the power stage of the circuit arrangement, should always be greater than a resonance frequency of the resonant circuit. If a switching frequency is lower than or the same as the resonance frequency, then a resonant operation is practically not controllable. In addition, lower frequencies produce undesirable audible noises.

In the method in accordance with the invention for driving the circuit arrangement now, departing from an output power of an induction cooking device, a reduction of the output power of an induction cooking device is achieved by a reduction of the resonance frequency of the resonant circuit by means of a variation of the variable switching element. In preference, a further reduction of the output power is achieved by a reduction of a driving degree of a supplying alternating current.

By a variation of the variable switching element it is assured, that a switch of a bridge circuit for supplying the resonant circuit every time is switched-on free of current. In particular, a transistor is switched-on free of current, when a recovery diode is under current. With this, no corresponding protection circuit is necessary, and its switching losses are thus eliminated. Furthermore, it is possible to prevent short-circuits across the power supply.

The circuit arrangement, in preference, is designed in such a manner, that when driving the circuit a transistor under current of a bridge branch is switched-off, the current then commutates on to a recovery diode of an opposite bridge branch. A transistor of this opposite bridge branch is switched-on, while the recovery diode is still in the conducting condition. A transistor therefore is only switched-on in a voltage-free condition.

In contrast, for example, to external wirings with the solution described no unsuitable conditions for a resonant circuit or a power stage are later on influenced, but they are either completely or almost completely prevented. With this, the partially massive switching losses are capable of being prevented.

The variable switching element in preference is wired in series with the at least one induction coil. If now a cooking dish with a certain inductivity and capacity is brought into the zone of action of the induction coil of the cooking device, this will have an effect on the resonance frequency of the resonant circuit. With an increasing of the inductivity a resonance frequency of the resonant circuit is reduced. A variation of the resonance frequency is also possible by means of the variable switching element, wherein with an increasing deviation of the resonance frequency from the switching frequency of the power stage, a power output to the resonant circuit and to the cooking device are reduced. With this a step-less variation, in particular a reduction of the power output is possible, in that, for example, with an unchanged switching frequency the resonance frequency is reduced. If now, additionally, a degree of level control (or degree of modulation) of the power stage is reduced, a device is capable of being operated with a very low power. On the basis of the reduced resonance frequency, it is possible to assure, that—in comparison with a driving, which only varies the degree of modulation—in case of high degrees of modulation a switch, resp., a transistor is switched-on current-free.

In a varied method for driving the circuit arrangement, by the variable switching element influences of differing inductivities or capacities of cooking dish materials on the inductivity and if so applicable also the capacity of the resonant circuit and with this its resonance frequency are compensated. In doing so, a frequency change of the resonant circuit caused by an induction cooking dish is capable of being equalised again by a variation of the controllable switching element. Controlling in preference is automatic, in that a predefined, in preference constant frequency is set. Preferably in such a case a variable switching element in a optimum condition, which, for example, corresponds to a very good induction cooking dish, is not driven.

With the circuit arrangement in accordance with the invention, it is possible to utilise the most diverse induction cooking dishes with the most differing inductivities and capacities. An induction cooking device equipped with an improved circuit of this kind in addition has the advantage, that cooking device and cooking dishes do not have to be supplied as matching one another or even together. With a simple and advantageous change it is possible also to improve existing induction devices and induction devices with several induction coils.

The circuit arrangement in accordance with the invention, in preference, is operated with a constant switching frequency of a supplying power stage. This provides the additional advantage, that several induction coils are able to be arranged next to one another in a device with a multiple cooking field, as is usual in gastronomy and in large kitchens. Typically these devices comprise a continuous cooking plate, e.g., a ceramic plate, which comprises several cooking fields. Assigned to every cooking field, in preference, is one or at least one induction coil, e.g., 2, 3 or 4 induction coils. By the operation of all induction coils with the same, constant frequency, mutual negative interferences are excluded. By the variable switching element directly in the resonant circuit a control parameter is now introduced. In preference the several supplying power stages of the several induction coils are supplied with power by a common direct current power supply.

It is, however, possible also to utilise several variable switching elements, which, for example, are capable of covering a broader induction-/capacity range.

### BRIEF DESCRIPTION OF THE DRAWINGS

In the following the invention is explained in more detail on the basis of schematic Figures. These illustrate:

FIG. 1 a switching circuit for an induction device according to prior art;

FIG. 2 a switching circuit with controlled choke.

FIG. 3a-c simulated coil current in differing operating modes of the circuit arrangement.

### DETAILED DESCRIPTION OF THE INVENTION

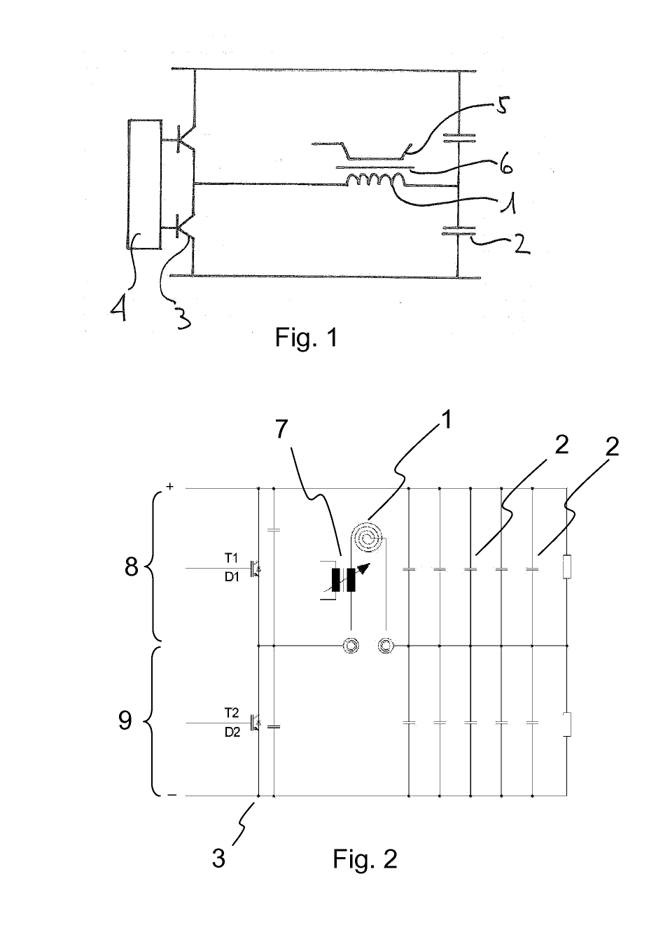

In FIG. 1 a circuit arrangement is depicted, as it is found in conventional induction devices. The arrangement comprises an induction coil 1, capacitors 2 and a power stage 3 connected with a control system 4. Switches of the power stage are electronic power switches, such as, e.g., power transistors of the most diverse type. Schematically indicated in addition is a cooking dish 5, which, when placed on a cooking plate 6, e.g., ceramic plate, interacts with the inductivity of the induction coil. Depending on the ferro-magnetic characteristics of the cooking dishes the influence on the induction coil is differing, manifests itself, however, in a change of the inductivity and/or capacity of the resonant circuit and with this of its frequency.

The frequency or switching frequency utilised in the switching circuit for driving the power stage 3 typically is varied between 20-40 kHz. With a frequency variation of the switching frequency it is possible to achieve, that the resonant circuit is operated in the vicinity of its resonance frequency and that an optimum operating point for the resonant circuit and/or the power stage 3 is produced.

The less optimum or matched to the resonant circuit of the induction device the material of a cooking dish is, the more energy is expended for the undesired heating-up of other circuit components, in particular for switching losses in the power stage 3. It is possible that this leads up to a non-functioning of an induction device.

For the “interception” of too high currents and corresponding switching losses in the power stage, there are external circuits (not illustrated) across the power stage 3. As already briefly described at the beginning, these solely prevent that too high currents flow, however, switching losses are still present and with this no active intervention in the resonant circuit of the induction circuit itself is possible.

In FIG. 2 an embodiment of the circuit arrangement in accordance with the invention is illustrated. The fundamental arrangement corresponds to that of FIG. 1, wherein the same elements are identified with the same reference marks.

Arranged in series with the induction coil 1 is a controllable choke 7, which in preference is driven with direct current. By a controlling of the choke deliberate frequency changes are able to be made, or also frequency changes equalised, which are caused on the basis of an induction change in the induction coil, which is caused by a cooking dish. The device, in preference, is adjusted in such a manner, that as standard value the operation of the device is adjusted with a ‘good’, therefore ideal, good ferro-magnetic cooking dish.

Two bridge branches 8, 9 of a bridge circuit form the power stage 3. A bridge branch respectively comprises a transistor T1, T2 and a recovery diode D1, D2 assigned to it. Not indicated is a direct current source, typically a rectifier circuit, which supplies the bridge circuit.

Depending on the operation of the circuit, the choke is either not driven or driven. If now a ‘worse’, therefore less ferro-magnetic cooking dish is utilised, the inductivity of the induction coil will reduce. Corresponding to this reduction, the choke is able to be driven, preferably automatically and is partially or wholly driven into saturation until the overall inductivity of the resonant circuit has equalised once more. In one example of a circuit, a choke comprises an inductivity range of typically 0-200 μH, e.g., 0-20 μH, 0-50 μH or 0-100 μH(Micro-Henry).

A choke provides the advantage, that it is a relatively cheap and not very error-prone circuit element with a limited space requirement. In addition, by one or several chokes a very wide induction -/capacity range is capable of being covered.

The indicated circuit arrangement is capable of being operated with a variable frequency. Then an optimisation of the resonant circuit is able to be implemented by the two control parameters frequency and variable switching element. In a preferred embodiment the circuit is operated with a constant frequency of, for example, 20 kHz (Kilo-Hertz). All frequency changes in the resonant circuit caused by the operation of an induction device are then capable (to a certain degree) of being compensated solely by the controlling of the choke. Alternatively it is possible to control a power supply to the resonant circuit, respectively, to the cooking device, by means of the choke.

It is also possible to utilise several chokes, which then in preference are connected in series.

Also conceivable are other variable circuit elements, with which the inductive and/or capacitive characteristics of the resonant circuit are able to be controlled. For example, instead of a choke controlled with direct current also a choke with a variably introducible core is able to be utilised. Because an influence of a cooking dish to the greatest extent causes inductivity changes, a controllable circuit element, which directly causes a balancing in the inductivity, is preferable. However, there are also controlled capacitors, which it is possible to include in the circuit in the form of steplessly controllable capacitors or as connected capacitor stages.

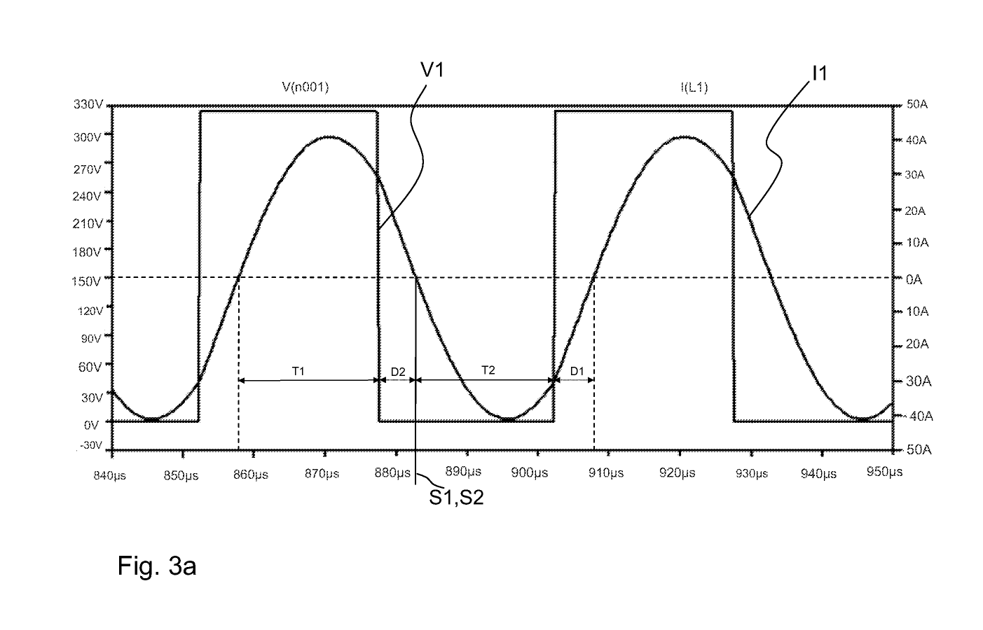

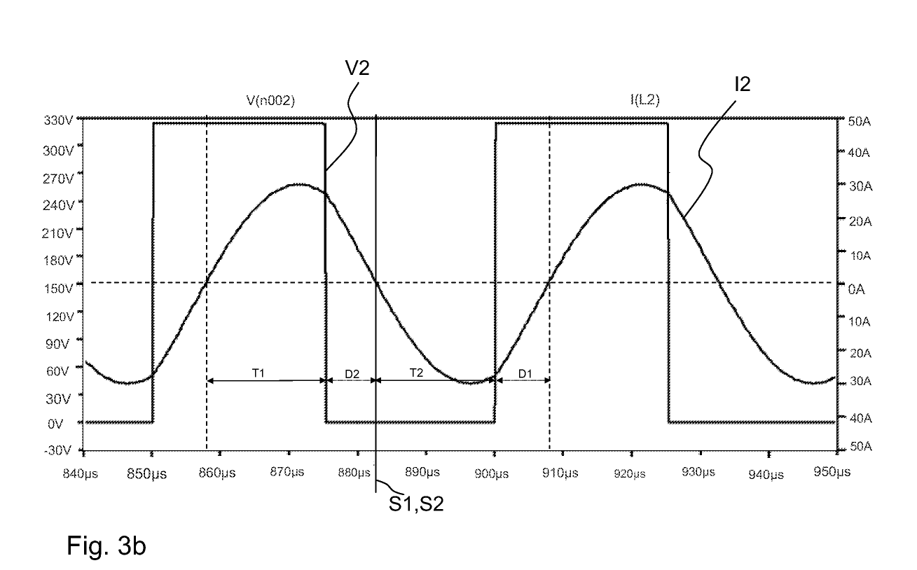

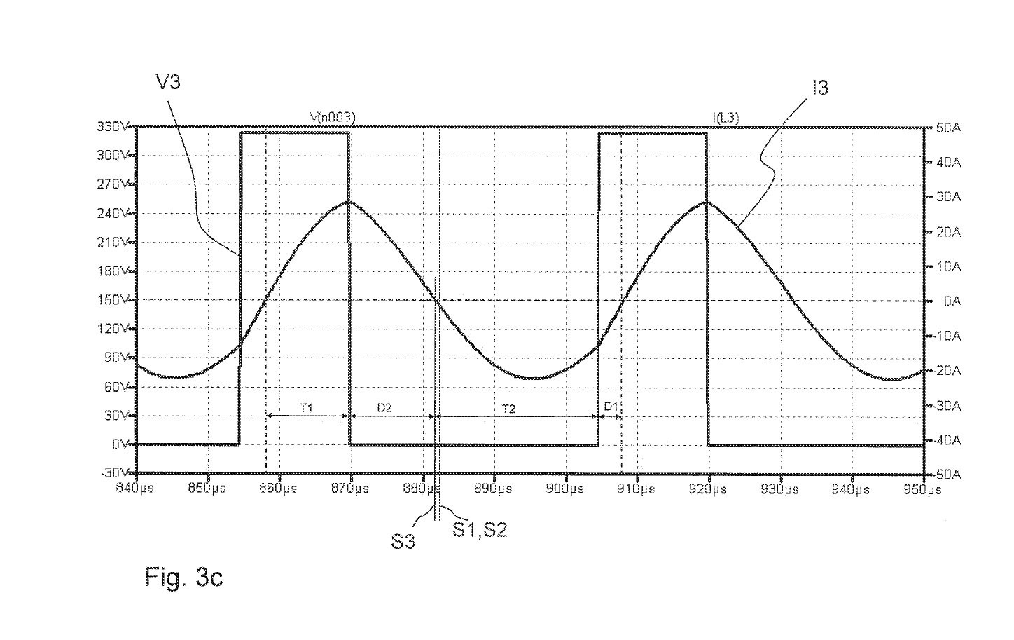

In FIGS. 3a to 3c, the voltage V1, V2, V3 at the bridge centre and therefore at the resonant circuit and the coil current I1, I2, I3 are depicted in accordance with the circuit arrangement according to FIG. 2, as it is indicated during differing operating modes. The switching frequency is the same in the case of all three operating modes. The arrows with the labelling T1, T2, D1, D2 describe, through which component the current flows T the corresponding point in time. The values of the circuit and of the operating mode used as examples are: 300V alternating voltage in differing modulations (V1-V3), inductivity 160 μH, resp., 180 μH, capacity 470 nF, resistance R=3.75 ohm.

In FIG. 3a, a maximum power output is achieved, in which the switching frequency lies in the vicinity of the resonance frequency of the resonant circuit and there is a full modulation (maximum degree of modulation). The resonance frequency in doing so is given by the formula f_{R}=1/2π√(LC). In this operating mode the control choke 7 is deactivated. The current curve 11 is to a great degree symmetrical. In this, the circuit is driven as follows: While the upper transistor T1 conducts, the current flows through the upper bridge branch 8. In the reducing phase of the current (approx. at 876 μs) the upper transistor T1 is switched-off. This takes place with a certain safety spacing to the zero transition of the current, because the zero transition is not accurately known due to the variability of the resonant circuit, and because later on the lower transistor T2 has to be switched-on current-free. Because of the switching-off of the upper transistors T1, the current commutates to the lower recovery diode D2. The switching point S1, at which the transistor T2 of the second, lower bridge branch 9 is switched-on, is at 0 Amp or shortly before, the transistor therefore is switched-on voltage-free and current-free. In principle, the transistor T2 is able to be switched-on during the whole time, during which the lower recovery diode D2 is conductive, this essentially voltage- and current-free. After the lower transistor T2 has taken over the current, the current is also able to flow through the lower bridge branch 9 to the recovery diode D2 in the opposite direction. After a certain time the current swings back again, and by switching-off the lower transistors T2 in an analogue manner the current commutates to the upper free-running diode D1 of the upper bridge branch 8 and then, as long as D1 is conductive, the upper transistor T1 is switched-on.

FIG. 3b illustrates the coil current 12 at a medium power, also however at full level. In doing so, the choke is activated and the resonance frequency as a result reduced and therefore at a greater distance from the unchanging switching frequency of the power stage than in the case of full power output as in FIG. 3a. With this, a power output is capable of being reduced steplessly up to a full saturation of the choke. The driving of the transistors T1, T2 takes place in analogy to that at full power.

Now theoretically by an even bigger choke the power output could be reduced even further. If, however, the resonant circuit is operated with a frequency, which deviates too strongly from its resonance frequency, the circuit becomes inefficient. Therefore now, as shown in FIG. 3c, a modulation (degree of modulation reduced, e.g, to <50%). For example, the upper transistor T1 is switched-off earlier. In order that the medium current stays zero, the lower transistor T2 has to be switched-off later. In order to now prevent an undesired short-circuit by the circuit, a modulation must only be reduced to such an extent, that a transistor is only switched-on, when the current flows through the appertaining diode (T1,D1, resp., T2,D2). Since, however, a resonance frequency by the connection of the control choke 7 has already been reduced, this problem is not applicable anymore for a broader range of the modulation.

The switching point S3, at which the transistor of the second bridge branch is switched-on, in contrast to the operation at full modulation, is displaced forwards in time to shortly before the zero transition of the current. With this it is avoided, that the current already flows in the ‘wrong direction’ and the transistor is not anymore capable of being switched-on current-free.

In a preferred embodiment of the method therefore a variable circuit element is utilised in series with an induction coil in combination with a variable degree of modulation of a power stage, in particular an IGBT drive.

1. Circuit arrangement for a induction cooking device, comprising:
a resonant circuit with at least one induction coil for the inductive heating-up of an induction cooking dish, and
at least one capacitor,
wherein the resonant circuit comprises a variable circuit element for the variation of the inductivity and/or the capacity of the resonant circuit.

2. Circuit arrangement in accordance with claim 1, wherein the variable circuit element is at least one controllable choke.

3. Circuit arrangement in accordance with claim 2, wherein the at least one controllable choke is controlled with direct current.

4. Circuit arrangement in accordance with claim 1, wherein the variable circuit element is connected in series with the at least one induction coil.

5. Circuit arrangement in accordance with claim 1, wherein a switching frequency for supplying the resonant circuit is constant.

6. Circuit arrangement in accordance with claim 1, wherein a frequency change of the resonant circuit on the basis of a change of the inductivity of the induction coil is equalised by variation of the controllable circuit element.

7. Method for driving a circuit arrangement in accordance with claim 1, comprising the step of: when departing from an output power of an induction cooking device, achieving a reduction of the output power is achieved by reduction of the resonance frequency of the resonant circuit by means of variation of the variable circuit element.

8. Method for driving a circuit arrangement in accordance with claim 7, wherein a further reduction of the output power is achieved by reduction of a degree of modulation of a supplying alternating current (V1,V2,V3).

9. Method for driving a circuit arrangement in accordance with claim 7, wherein switches of a bridge circuit for supplying the resonant circuit every time are switched-on current-free.

10. Method for driving a circuit arrangement in accordance with claim 9, wherein when a current carrying transistor (T1, T2) of a bridge branch is switched-off, the current commutates to a recovery diode (D1, D2) of a opposite bridge branch, and a transistor (T1, T2) of this opposite bridge branch is switched-on, while the recovery diode (D1, D2) is still in the conductive condition.

11. Induction cooking device with a circuit arrangement in accordance with claim 1.

12. Induction cooking device in accordance with claim 11, comprising several induction coils, wherein to every induction coil a circuit is assigned comprising resonant circuit with at least one induction coil for the inductive heating-up of an induction cooking dish, and at least one capacitor, wherein the resonant circuit comprises a variable circuit element for the variation of the inductivity and/or the capacity of the resonant circuit.

13. Induction cooking device in accordance with claim 12, which is set-up to supply the several induction coils with the same switching frequency.

14. Induction cooking device in accordance with claim 11, further comprising a continuous cooking plate comprising several cooking fields, wherein to every cooking field at least one induction coil is

15. Combination of an induction cooking device in accordance with claim 11 and at least one induction cooking dish.
